(19) United States
(12) Patent Application Publication
(10) Pub. No.: US 2002/0059614 A1
(43) Pub. Date: May 16, 2002

(54) System and method for distributing digital content in a common carrier environment

(76) Inventors: Matti Lipsanen, Turku (FI); Pekka Talmola, Turku (FI); Hasse Sinivaara, Espoo (FI)

Correspondence Address: MORGAN & FINNEGAN, L.L.P., 345 Park Avenue, New York, NY, 10154, US

(21) Appl. No.: 09/999,234

(22) Filed: Oct. 31, 2001

Related U.S. Application Data
(63) Continuation-in-part of application No. 09/384,882, filed on Aug. 27, 1999.

(51) Int. Cl. H04N 7/16; H04N 7/18

(52) U.S. Cl. 725/75; 725/1; 725/77; 725/30

(57) ABSTRACT

A system and method for distributing digital content on-demand in a common carrier environment, such as an airplane, are disclosed. The present invention employs a combination of low power RF (e.g., WLAN/Bluetooth) and digital data broadcast (e.g., DVB-T) technology to distribute digital content to passengers in an airplane cabin. In an advantageous embodiment, a mobile multimedia terminal (or, alternatively, a fixed seat-back terminal), with a WLAN or Bluetooth link to a content server aboard the plane is used by a passenger to request digital content such as movies, music, games, etc. In response, the server transmits the requested content to the passenger's device via a DVB-T connection. The elimination of a wired connection for each of, for example, 400+ passengers in a Boeing 747, decreases the overall weight of the system and thus reduces fuel costs. A mechanism is also disclosed for quickly updating content in the airplane's server via a DVB-T connection while the plane is at a gate receiving flight and operational data for its next flight.

### FIELD OF THE INVENTION

This invention relates to multimedia terminals and, more particularly, to a system and method for distributing digital content on-demand in a common carrier environment.

### BACKGROUND OF THE INVENTION

The explosion of wireless data communication has been fueled by advances in semiconductor technology and software. These advances have allowed audio and data signals to be transmitted over digital networks.

Digital and mixed signal systems offer many advantages over old-fashioned analog systems. One important advantage is the ability of digital systems to transmit and receive more information at higher rates. Whereas analog systems are limited to transmitting audio and video at a rate of 64 Kbps, digital systems can compress such transmissions to transmit eight times as much information at the same rate. Moreover, faster processors have allowed digital systems to transmit bits at ever increasing rates. By taking advantage of the compression routines and faster processors to transmit information more accurately and at higher rates, significant savings have been realized in both switching capacity and ongoing line costs.

Additional advantages have been realized through the use of multiple access techniques such as Time Division Multiple Access (“TDMA”) and Code Division Multiple Access (“CDMA”). These techniques allow for multiple users to access a single bandwidth. They also allow for audio and data signals transmitted by a single user to be intermingled. These techniques make better use of scarce airwave space.

A recent development in the wireless information revolution has been the transmission of digital video signals over the airwaves, for example, using DVB-T. A similar development is occurring in the RF band, as efforts are being made to add video capability to cellular telephones, fax machines and computers. Before quality video capability can be added to these machines, however, a problem arising from bandwidth limitation must be overcome. Because these machines operate on frequencies between 900 and 1900 Mhz, the bandwidth is not wide enough to transmit the enormous amount of video and audio information that is required for quality motion pictures.

Digital television provides more channels at a higher quality than is currently available with analog broadcasts. One analog channel provides the bandwidth capacity for one high-definition (HDTV) digital broadcast or several standard definition (SDTV) digital broadcasts. Digital television is scalable between these two extremes. Therefore, digital broadcasters can make a trade-off between vastly improved image and sound quality and an increased number of programming choices.

Digital television is deliverable to moving receivers. Currently, analog television reception is non-existent or severally limited in moving receivers. However, digital receivers allow for clear reception in cars, buses, trains, and in handheld television sets such as the Sony Watchman™.

Most of the equipment used to create, edit, and distribute television programs is now digital. The analog reception of a television signal, via cable, aerial, or satellite, is the end result of a long chain of events, most of which have taken place in the digital domain. For example, in delivering a new broadcast, the field reporter uses digital satellite news gathering equipment to uplink her report to a programming center. The material is digitally received, decoded, and compiled with live program feeds in a studio. The broadcast is then sent digitally around the world to professional receivers. Finally, the broadcast is converted to an analog signal and sent to the end viewer.

An intelligent TV can receive communication services by connecting a TV to a value added network (VAN). The intelligent TV includes an information signal processing unit for receiving information communication data (hereinafter, “information data”) when the intelligent TV is connected to the VAN, and for generating information RGB signals, and switching control signals in order to display the information data on a screen. The intelligent TV selects and displays on the screen one of the information data signals processed in the information signal processing unit and a TV RGB signal processed in a TV signal processing unit, in accordance with the switching control signal output from the information signal processing unit. Intelligent TV makes it possible to view, through a TV screen, several communication services, such as stock quotes, news services, weather reports, and TV program lists, being transmitted through the VANs. Therefore, it has an advantage that persons who are not familiar with the usage of a computer can easily receive communication services.

Even though intelligent TV has the advantage of receiving communication services through the TV screen, it cannot display multiple signals at the same time. Information signals for displaying information data on a screen, a TV signal, a Picture-In-Picture (PIP) signal for enabling two screens to be viewed simultaneously, and a TV on-screen-display (OSD) signal must be displayed one at a time. Therefore, signals are displayed according to a predetermined priority. For example, an information signal is displayed preferentially over a TV signal, a PIP signal is displayed preferentially over an information signal, and a TV OSD signal is displayed preferentially over a PIP signal.

Current information delivery services described above lack many features that would enhance their usability and desirability by the public. As mentioned, the intelligent TV lacks an ability to display multiple signals simultaneously. In addition, an online connection of two delivery services with one of the services being, for example, an interactive application, is not available. Current technologies are dependent on stationary receivers. Since multiple signals cannot be integrated by the integrated receiver/decoder (or IRD), information delivery is dependent on the location or site.

New display technologies provide the possibility to build low power and high quality portable display devices. These devices are based on large full color flat panel displays or on virtual (helmet mount) displays. The common denominator for these kinds of displays is that they are digital and matrix type displays. Introduction of DVB-T enables, for the first time in TV broadcast history, the possibility of truly mobile reception of TV. In addition to conventional TV services, DVB-T provides access to broadcast data services. Integration of DVB-T with digital display unit, such as the flat panel or helmet mount displays described above, makes it possible to build fully digital TV receiver with studio quality picture.

FIG. 3 depicts a block diagram of the current multimedia architecture. Currently, the digital set-top-box (STB) 302 and digital TV display 304 are separate. Furthermore, the STB 302 communication link is only of a single type. For example, the STB communications link is a hard interface such as coax-cable or POTS. Therefore, the typical digital TV 304 connected to an STB 302 offers no portability or mobility.

Laptop and notebook computers are now equipped with the means to connect to networks using a mobile (or wireless) link. Such connections usually utilize a modem and digital wireless transceiver built on a single card, e.g., a PCMIA card. However, digital TV receivers have not been integrated into such devices. One reason for this lack of versatility is that digital TV receivers have high power consumption rates (relative to other laptop or notebook functions). Thus, the battery power of a laptop would be consumed rapidly. In addition, laptops, like STBs, are typically limited in their ability to communicate externally. For example, a serial port, parallel port and possibly a modem can be used to distribute information from a laptop. However, such devices do not switch between these links seamlessly. Further, such devices do not have the ability to take stock of their environment and dynamically switch to the most appropriate communication link.

Video-On-Demand (“VOD”) and Audio-On-Demand (“AOD”) services have become prevalent in common carrier environments, particularly aboard commercial airplanes. However, such services are currently only available using wired systems and fixed seat-back terminals. Installation, maintenance and operation of the huge amount of wiring between each seat-back terminal and the content server can be expensive. Moreover, the extra weight introduced by the wiring can increase fuel costs significantly. Adding to such expenses, is the labor-intensive and time consuming method of updating content in the content server for each flight. Updating VOD/AOD content requires an airline representative to physically carry the content aboard the plane in the form of a CD-ROM or DVD and download the content into the server. The aviation industry is currently developing a Wireless Gatelink system in accordance with WLAN 802.11 protocols, whereby flight operational data can be transmitted to the airplane's flight databases via a wireless connection. However, even if modified for downloading VOD/AOD content, this system would still be relatively slow for large scale downloads, something which is less than optimal given the relatively fast turn-around gate times required of an airplane between flights (90 minutes nominal).

### SUMMARY OF THE INVENTION

The above-identified problems are solved and a technical advance is achieved in the art by providing a system and method for distributing digital content in a common carrier environment.

An exemplary system for distributing digital content to passengers in an airplane includes: a terminal for transmitting a passenger request for content and for receiving content in response thereto; a server for responding to the passenger request for content; an access point coupled to the server for receiving the passenger request for content from the terminal via a short range wireless link and communicating the request to the server; and a digital data broadcast transmitter for broadcasting requested content from the server to the terminal.

In another embodiment, directed to updating content in an airplane's on-board content data base while the airplane is parked at a gate, an exemplary system includes: a storage medium for storing content; an access controller; an access point coupled to the access controller for receiving a request for content from the airplane via a short range wireless link and communicating the request to the access controller; and a digital data broadcast transmitter for broadcasting content from the storage medium to the airplane in response to the request to update content in the airplane's on-board content data base.

Thus, in accordance with one embodiment of the present invention, wireless distribution of digital content in a common carrier environment, such as an airplane, is achieved. In accordance with an alternate embodiment the present invention, the latest content updates can be uploaded to the airplane's databases quickly and efficiently while the plane is parked at a terminal gate between flights.

Other and further aspects of the present invention will become apparent during the course of the following description and by reference to the attached drawings.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 depicts the presently preferred embodiment of the mobile multimedia terminal;

FIG. 2 depicts the presently preferred embodiment of a MMT and its corresponding communications environment;

FIG. 3 depicts a block diagram of the current multimedia architecture; and

FIG. 4 depicts a block diagram of a mobile station 400 that can act as an IP router or portable base station to the MMT 100.

FIG. 5 is a block diagram of an exemplary MMT 500 for requesting, receiving and processing content in a common carrier environment in accordance with one embodiment of the present invention.

FIG. 6 is a block diagram of an exemplary system for receiving requests from, and transmitting content to, the MMT 500 of FIG. 5 in accordance with one embodiment of the present invention.

FIG. 7 is an exemplary database used by the system of FIG. 6 in routing content to an appropriate DVB-T transmitter.

FIG. 8 is an exemplary data base used by the system of FIG. 6 in broadcasting content to a MMT 500.

FIG. 9 is a block diagram illustrating an exemplary mechanism by which the MMT 500 of FIG. 5 determines which packets to filter from a multiplexed transport stream in order to consume requested content.

FIG. 10 is a block diagram of an exemplary system for quickly updating content in an airplane's content database server via a DVB-T connection while the plane is at a terminal gate receiving flight and operational data for its next flight.

### DETAILED DESCRIPTION OF THE PREFERRED EMBODIMENTS

The numerous innovative teachings of the present application will be described with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

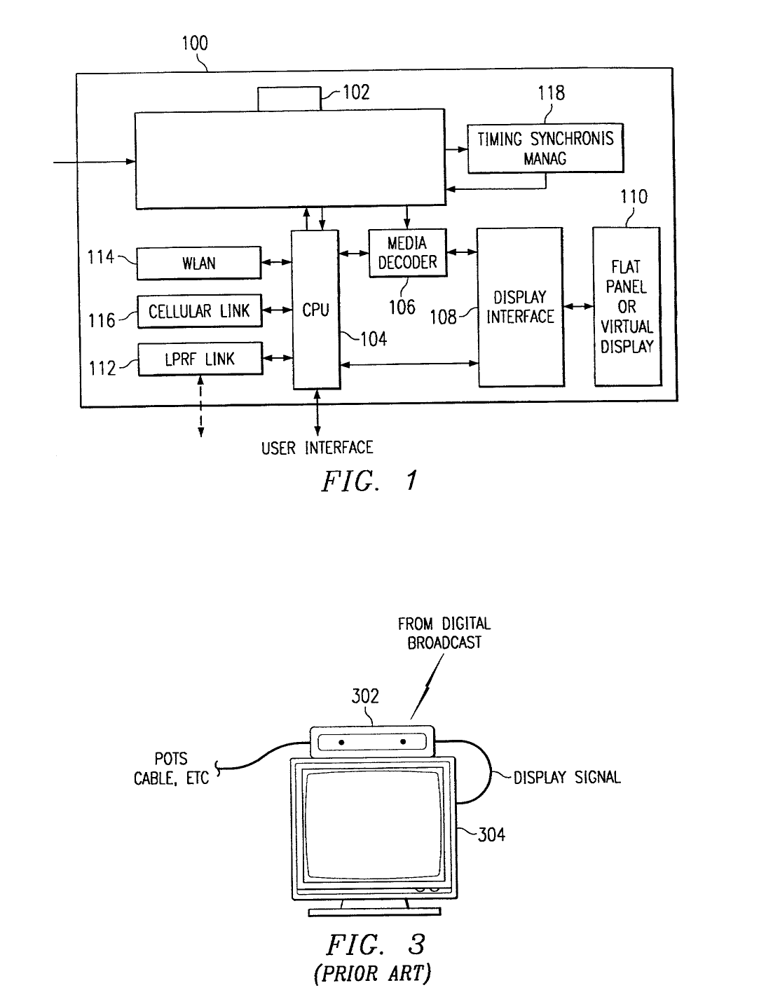

FIG. 1 depicts the presently preferred embodiment of the mobile multimedia terminal (or MMT). The MMT provides an interactive, mobile environment. In the presently preferred embodiment, a DVB-T receiver 102 is controlled by a CPU 104. The DVB-T receiver 102 is capable of receiving digital TV broadcasts according to the DVB-T standard. DVB-S (satellite) and DVB-C (cable) broadcasts are also standardized and may be used. The DVB-T standard specifies a broadband channel, preferably in the VHF frequency range, that carries a digital data stream. In addition to TV broadcasts, channels in the DVB-T spectrum can be used to transmit data intended for receipt by specific users. Such data is generally encrypted for privacy. In this manner, DVB-T (or DVB-S or DVB-C) can be used for data transmission which requires a wideband downstream channel (from the source to the requester). In the presently preferred embodiment, the MMT 100 is the requester.

A media decoder 106 is controlled by the CPU 104 and used to decode the received DVB-T broadcast. The DVB-T broadcast standard uses MPEG-2 encoding. Therefore, in the presently preferred embodiment, the media decoder 106 is an MPEG-2 decoder. However, other forms of streaming video can and do use alternate protocols to transmit digital data. The media decoder 106 selected should be designed to match and decode the transmission protocol used by the digital data source.

A display interface 108 receives the decoded broadcast from the media decoder 106. The display interface 108 is designed to optimize the display of data to a user of the MMT 100. For example, the digital data received can be in the form of full motion video or it can be a graphic of some kind. The differing formats require differing modes to be optimally displayed. The display interface 108 acts as a video integrator. For example, the display interface can place a graphics overlay onto full motion video, manipulate the display of full motion video into a certain part of a display, or crop some video or graphics to show only their essential or moving parts on a display. The output of the display interface 108 drives a display 110 for the MMT 100.

In addition to processing a digital broadcast signal, the MMT 100 of the presently preferred embodiment is capable of transmitting information. Such information can include requests for information, data to be downloaded via digital broadcast, phone identification data, or regular voice and data communications over a mobile station (such as a mobile phone). In the presently preferred embodiment, the MMT 100 is equipped with a low-power radio frequency (LPRF) e.g., Bluetooth, transceiver 112. A transceiver configured according to the Bluetooth standard is capable of short range (approximately 10 meters) radio communication to a local transceiver. The local transceiver can be connected to a LAN, PSTN, or a low or high power wireless network. In addition to a LPRF link, the MMT 100 of the presently preferred embodiment can be configured with a Wireless-LAN 114 or cellular transceiver 116. The cellular transceiver can be, for example, a GSM, TDMA, CDMA, AMPS, or other standard or proprietary communications protocol. The CPU controller 104 of the MMT 100 is configured to select the mode of communication between transceivers 112, 114, and 116 dynamically. The CPU 104 can select the appropriate communications link according to the current communications environment. For example, if a Bluetooth transceiver is detected, data can be exchanged using the Bluetooth transceiver 112 without the need for acquiring a channel on a cellular link. However, if voice data is to be transmitted, a cellular link would be desirable. Thus the CPU 104 would select the cellular transceiver 106 for transmission duties.

The LPRF link 112 of the MMT 100 can be used in conjunction with an external mobile station. The external mobile station can act as a portable (close range) base station. The external mobile station can also act as an IP router for web browsing and other network activities.

The DVB-T receiver 102 of the MMT 100 is activated or deactivated by the CPU 104. The DVB-T receiver 102 can be activated at user request. That is, when the user wishes to receive broadcast data or is expecting to receive broadcast data. The CPU 104 can also monitor the environment for service information and activate the DVB-T receiver 102 if conditions warrant it. For example, if services the user wishes to receive are detected, the CPU 104 can activate the DVB-T receiver 102. As another example, the CPU 104 can activate the DVB-T receiver 102 if and when it needs to, in order to impart important or timely data to the user, e.g., weather or news data.

In the presently preferred embodiment, the DVB-T receiver 102 is equipped with a timing element 118 enabling it to remain synchronous with the digital broadcast facility. This timer 118 makes it possible to switch on the receiver and pick up the selected data packets days after the last system synchronization. The timer 118 allows the CPU 104 to control activation of the DVB-T receiver 102, and thus, also enables power savings. For example, if video functionality is not currently in use, that is, digital broadcasts are not being or do not need to be received, the DVB-T receiver 102 is switched off by the CPU 104. Such a situation can occur when, for example, the MMT is web browsing over a communications link 112, 114, or 116. To the extent that the DVB-T transport stream includes time stamps that enable the decoder to synchronize with the transport stream, the timing element 118 is not necessary.

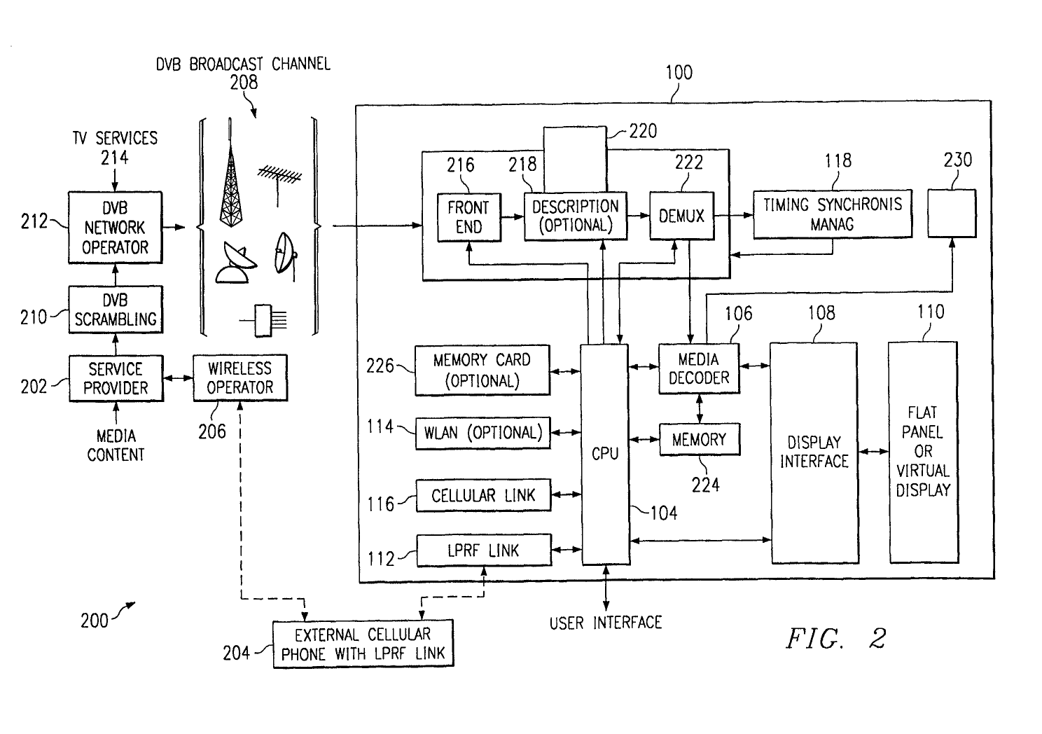

FIG. 2 depicts the presently preferred embodiment of a MMT 100 and its corresponding communications environment 200. Media is provided by a service provider 202. Media can include, for example, data services, decryption keys for smart cards, digital TV, digital audio, or other digital data. The media can be provided on the request by user or under a “broadcast” principle. In the presently preferred embodiment specific requests for data are handled via a mobile station 204 equipped with an LPRF transceiver. The requests are transmitted via an LPRF link from the MMT 100 to the mobile station 204. The mobile station 204 relays the request via a wireless operator 206. The service provider 202 capable of providing the requested data receives the request from the wireless operator 206. The media content is routed from the service provider 202, via DVB-scrambling 210, to a DVB Network operator 212. The DVB Network operator 212 multiplexes the media content with free to air TV Services 214 and transports the data over a DVB broadcast channel 208.

At the MMT 100, the DVB-T transmission is received by the DVB-T receiver 102. A front end receiver 216 in the DVB-T receiver 102 receives the transmission, acting as the over-the-air interface of the receiver 102. Data is transmitted to a descramber 218 with a smart card 220. The descrambler 218 is optional in the presently preferred embodiment. The decrypted/descrambled data is then forwarded to a demultiplexer 222.

The front end 216, descrambler 218, smart card 220, and demultiplexer 222 consume a majority of the power used by the DVB receiver 102. Data for the demultiplexer 222 is routed to the media decoder 106. Alternatively, the data can be routed to buffer or storage memory 224 or an optional memory card 226. Storing the data instead of decoding and displaying it is dependent on the set up and usage of the DVB-T receiver 102. For example, by storing data into memory, it is possible to display one data stream while receiving another. In the presently preferred embodiment, the timing and synchronization manager 118 controls the front end 216, descrambler 218, smart card 220, and demultiplexer 222. The timing and synchronization manager 118 activates these receiver components only when needed or upon user request. The CPU 104 of the MMT 100 controls all of the components of the MMT. The CPU 104 is responsible for reading the service information and determining the communication environment of the MMT 100. The CPU 104 is used to configure the timing and synchronization manager 118.

Content to be shown on the display 110 of the MMT 100 can originate either from CPU 104 via memory 224 or 226 or from media decoder 106. The display of the MMT 100 can be, for example, a flat panel TFT display or a virtual display such as a head mounted LCOS 3D display. Display data is processed by the display interface 108 of the MMT. This interface 108 performs the needed operations of scaling, zooming, frame rate conversions, filtering, in order to appropriately display the data on the display 110 of the MMT 100. The display interface 108 can be configured to optimally display data depending on its type and the type of display 110 to be utilized.

Digital content can also include audio signals. Such content can be presented through the audio output 230 of the MMT 100. The audio output 230 of the MMT can be, e.g., speakers.

The MMT 100 can be configured to communicate in a variety of ways. For example, an LPRF link 112 can be used to communicate with a mobile station acting as a portable base station or IP router. For another example, in a home gateway environment, the MMT 100 can act as a node in a Wireless LAN using a WLAN transceiver 114.

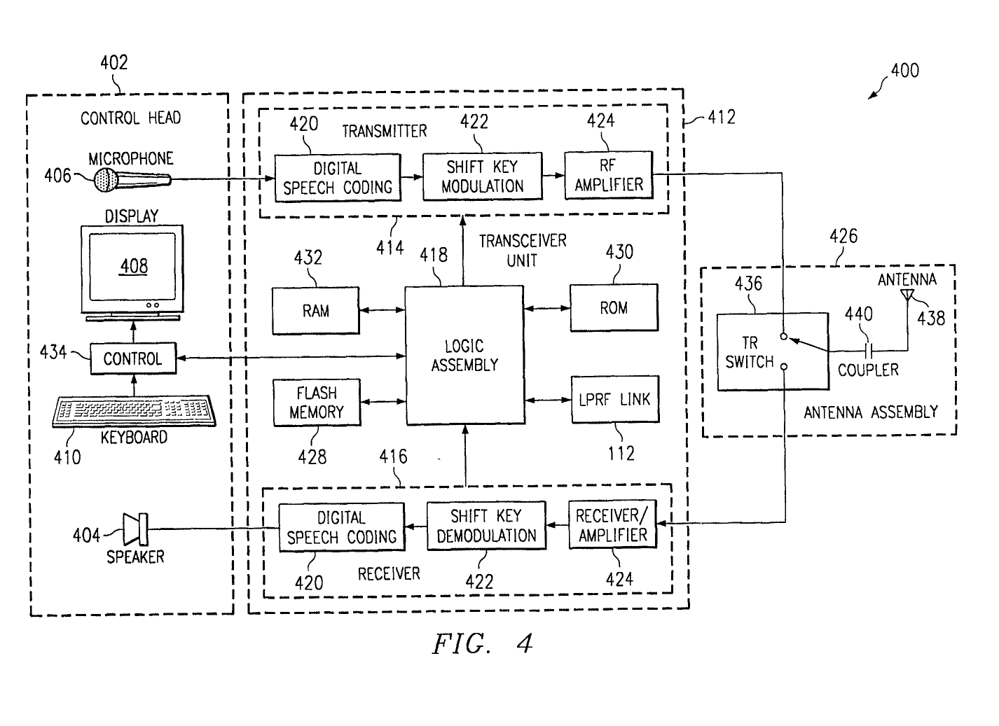

FIG. 4 depicts a block diagram of a mobile station 400 that can act as an IP router or portable base station to the MMT 100. The mobile station 400 includes, in this example:

A control head 402 containing an audio interface, i.e. a speaker 404 and microphone 406.The control head 402 generally includes a display assembly 408 allowing a user to see dialed digits, stored information, messages, calling status information, including signal strength, etc. The control head generally includes a keypad 410, or other user control device, allowing a user to dial numbers, answer incoming calls, enter stored information, and perform other mobile station functions. The control head also has a controller unit 434 that interfaces with a logic control assembly 418 responsible, from the control unit perspective, for receiving commands from the keypad 410 or other control devices, and providing status information, alerts, and other information to the display assembly 408;

A transceiver unit 412 containing a transmitter unit 414, a receiver unit 416, and the logic control assembly 418. The transmitter unit 414 converts low-level audio signals from the microphone 406 to digital coding using a codec (a data coder/decoder) 420. The digitally encoded audio is represented by modulated shifts, for example, in the frequency domain, using a shift key modulator/demodulator 422. Other codes transmission utilized by the logic control assembly 418, such as station parameters and control information, may also be encoded for transmission. The modulated signal is then amplified 424 and transmitted via an antenna assembly 426;

The antenna assembly 426 contains a TR (transmitter/receiver) switch 436 to prevent simultaneous reception and transmission of a signal by the mobile station 400. The transceiver unit 412 is connected to the antenna assembly 426 through the TR switch 436. The antenna assembly contains at least one antenna 438;

The receiver unit 416 receives a transmitted signal via the antenna assembly 426. The signal is amplified 424 and demodulated 422. If the signal is an audio signal, it is decoded using the codec 420. The audio signal is then reproduced by the speaker 404. Other signals are handled by the logic control assembly 418 after demodulation 422; and

A logic control assembly 418 usually containing an application specific integrated circuit (or ASIC) combining many functions, such as a general purpose microprocessor, digital signal processor, and other functions, into one integrated circuit. The logic control assembly 418 coordinates the overall operation of the transmitter and receiver using control messages. The various disclosed embodiments make use of the logic control assembly to control scanning and evaluation of other base stations. Generally, the logic control assembly operates from a program that is stored in flash memory 428 of the mobile station. Flash memory 428 allows upgrading of operating software, software correction or addition of new features. Flash memory 428 is also used to hold user information such as speed dialing names and stored numbers.

In addition to flash memory 428, the mobile station will typically contain read only memory (ROM) 430 for storing information that should not change, such as startup procedures, and random access memory (RAM) 432 to hold temporary information such as channel number and system identifier.

In the presently preferred embodiment, the mobile station also includes an LPRF transceiver 112, e.g., Bluetooth, for communication with the MMT 100.

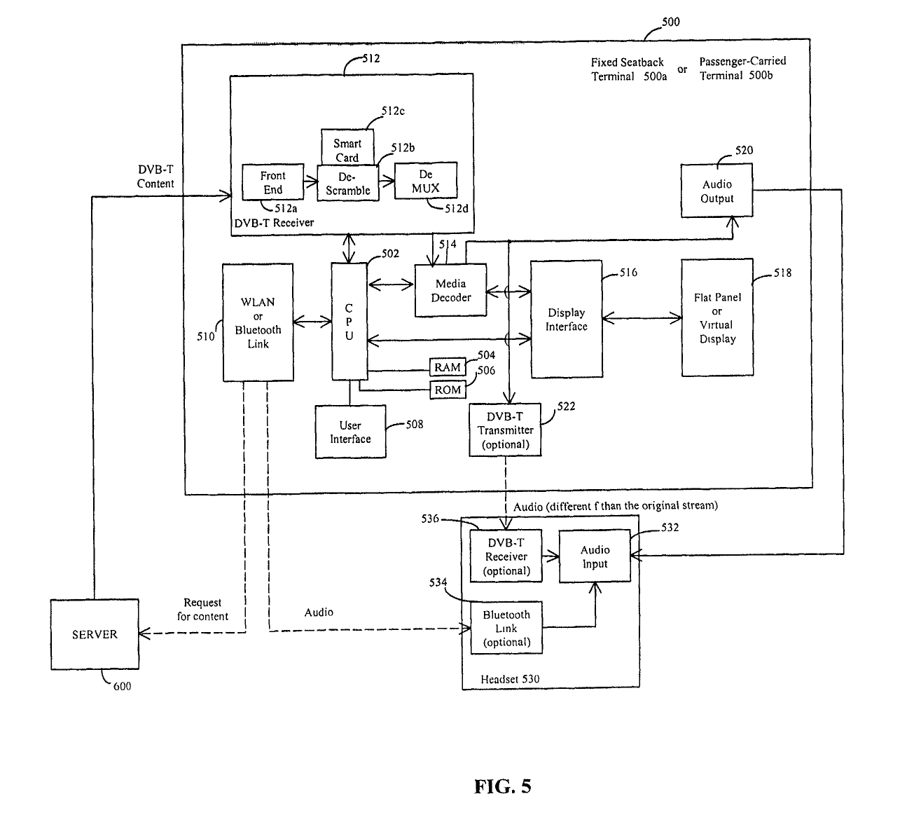

FIG. 5 is a block diagram of an exemplary MMT 500 for requesting, receiving and processing digital content in a common carrier environment, such as an airplane, in accordance with one embodiment of the present invention. MMT 500 may be a fixed seat back terminal 500a available for passenger use. Alternatively, MMT may be a passenger-carried terminal 500b, such as a Nokia developed Mobile Display Appliance (MDA), a Personal Data Assistant (PDA), a laptop computer, a headset display unit or the like.

As shown in FIG. 5, MMT 500 includes a CPU 502 and associated memory (504, 506) for, among other things, processing passenger requests for content and consuming content. MMT 500 also includes a DVB-T receiver 512 for receiving DVB-T broadcasts of digital content from a server 600 in response to requests from a user of MMT 500. The DVB-T broadcasts include a multiplexed transport stream, which contains one or more packetized streams of content together with overhead information. The content may include any content available for user consumption such as movies, audio recordings, games and the like. The overhead information preferably includes a programming guide comprising a web page (e.g., html) for display on MMT 500.

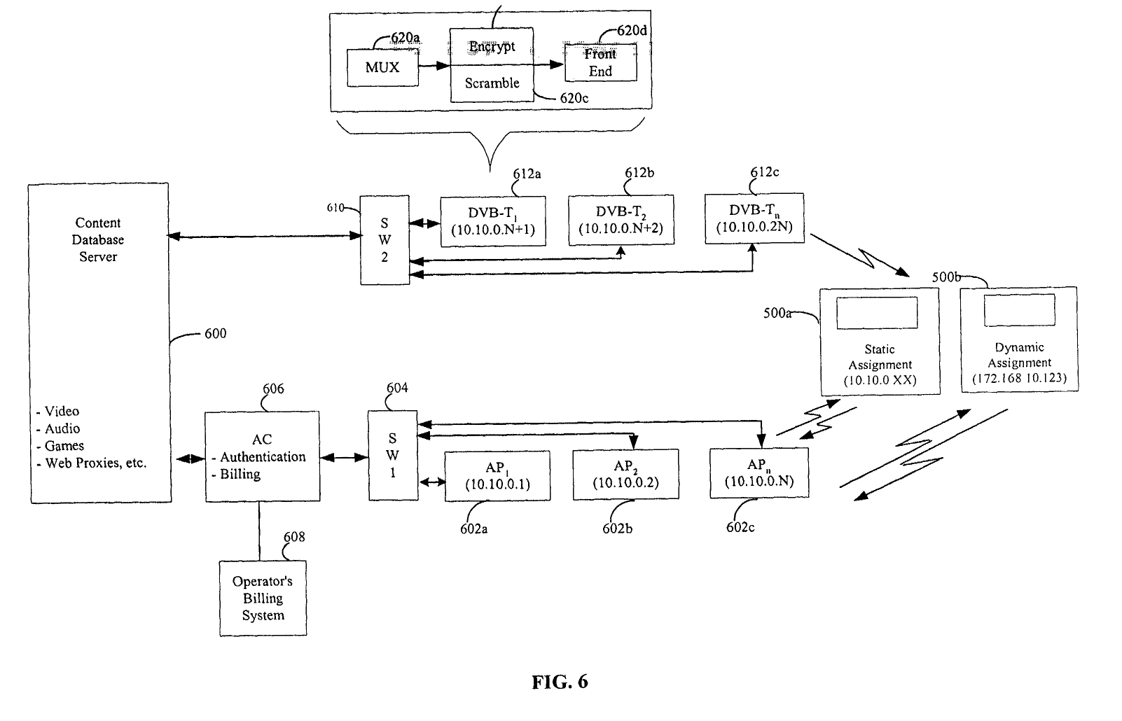

The web page contains a list of all content available in server 600 for user consumption, and, more particularly, includes links to that content. When a user selects one of the links (e.g., using a keypad and/or mouse device), MMT 500 transmits a content request message to server 600 via a bi-directional low power radio frequency (RF) transceiver 510 such as a 2.4 GHz 802.11b WLAN or Bluetooth transceiver. It is to be understood, however, that other radio techniques may be employed for this purpose, including, but not limited to, 5 GHz 802.11a/HiperLAN2, 3G, GSM, GPRS, EDGE, etc. After server 600 conducts user authentication and billing (also via the bi-directional transceiver 510), as will be discussed in detail hereinafter in connection with FIG. 6, server 600 broadcasts the content to DVB-T receiver 512 of MMT 500 using a DVB-T link.

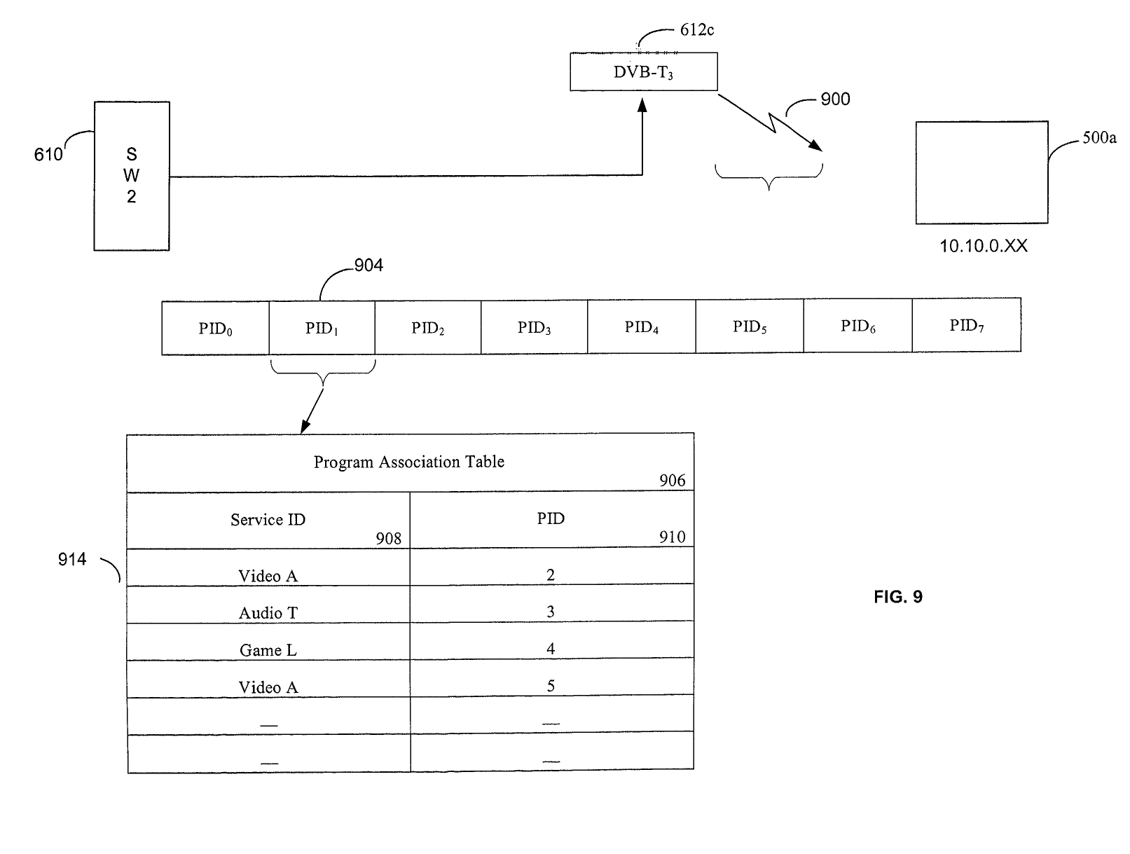

As shown in FIG. 5, DVB-T receiver 512 includes a front end receiver 512a, which acts as the over-the-air interface. Received data is then transmitted to a descrambler 512b with a smart card 512c. The decrypted/descrambled data, which includes both content and overhead, is then forwarded to demultplexer 512d. The overhead information, in addition to the aforementioned programming guide, also includes a service information (“SI”) channel, which contains information that permits DVB-T receiver 512 of MMT 500 to determine which packets in the multiplexed transport stream contain the requested content, and thus, which packets it should filter from the stream for user consumption, as will be discussed in detail hereinafter in connection with FIG. 9. The filtered data from demultiplexer 512d is then routed to media decoder 514, which decodes the received DVB-T broadcast. The media decoder 514 is designed to match and decode the transmission protocol used by the digital data source. The DVB-T broadcast standard uses MEG-2 encoding, and thus, in the preferred embodiment, media decoder 514 is an MPEG-2 decoder. The decoded content is then rendered using an appropriate software application, such as Windows Media Player™. It should be noted that the decoded content may be either pre-formatted for use by the application or, alternatively, will be formatted in real-time by MMT 500, as will be discussed in detail hereinafter in connection with FIG. 6.

Media decoder 514 transmits the video portion of the decoded broadcast (if any) to display interface 516, which, as discussed above in connection with FIG. 1, performs the operations of scaling, zooming, frame rate converting and filtering, as needed to appropriately display the video data on display 518, and is preferably designed to optimize the display of data to a user of MMT 500. The output of the display interface 516 is then used to drive the display 518 of MMT 500. Display 518 may be, for example, a flat panel display or a virtual display such as a head-mounted 3D display. Also, media decoder 514 transmits the audio portion of the decoded broadcast to audio output 520, which may be either a speaker or a wired connection to headset 530. Alternatively, media decoder 514 may transmit audio to a headset 530 via a low power radio frequency (RF) transceiver 510 (WLAN, Bluetooth or the like), provided that headset 530 is similarly equipped with an appropriate low power RF receiver 534. Alternatively, in the event that small-sized DVB-T transmitters become available in the future, audio can be transmitted to headset 530 via DVB-T transmitter 522 and received by DVB-T receiver 536 operating at different frequencies than that used to broadcast the DVB-T content to MMT 500.

FIG. 6 is a block diagram of an exemplary system for receiving requests from, and transmitting content to, fixed seat-back terminals 500a and/or passenger-carried terminals 500b in a common carrier environment, in accordance with one embodiment of the present invention. As shown in FIG. 6, the exemplary system includes content database server 600, which hosts all digital content available for passenger consumption. Such content may include, but is not limited to, videos, music, games, news, web proxies and the like. When updated into database server 600, the content may be encoded into a format for consumption (such as Windows Media Player™) that MMT 500 can run directly, thereby requiring less processing power in the MMT 500. This may be particularly advantageous in a system that employs only seat-back terminals 500a since such terminals would likely be configured to use the same application for consuming content. Alternatively, the formatting may be performed by the MMT 500 in real-time thereby permitting a passenger-carried terminal 500b to use an application different than the one used by seat-back terminals 500a (e.g., Real Player™, rather than Windows Media Player™) or different than the applications used by other passenger-carried terminals 500b.

Server 600 is also coupled to access controller 606, which is preferably a Nokia P022 Access Controller. Access controller 606 may be a stand-alone device such as the Nokia P022 or, alternatively, may be hardware and/or functionality incorporated into content database server 600. Access controller 606 performs a variety of functions, which will be discussed in detail hereinafter, including authenticating users, tracking charges incurred for content, tracking network addresses (e.g., IP addresses) of access points 602, DVB-T transmitters 612 and MMT's 500 and routing content to an appropriate DVB-T transmitter 612 for broadcast to MMT 500 based on the access point 602 from which the content request was received.

As shown in FIG. 6, access controller 606 is also coupled to a plurality of access points 602a-c via a switch 604. Each access point 602 has assigned to it a static IP address, which is stored in access controller 606. Each access point 602 serves a predetermined area within the plane, such as a group of seats, by communicating requests for content and authentication information between MMT's 500 and access controller 606. The fixed seatback terminals 500a associated with those seats, as part of the local area network (LAN), also have statically assigned IP addresses, which also are stored in access controller 606. In the event that MMT 500 is a passenger-carried terminal 500b, access controller 606 will assign an IP address from its dynamic host configuration protocol (DHCP) pool to the terminal upon receipt of a request. Thus, access controller 606 can determine from which access point 602 a request has been received and the particular terminal that originated the request.

As also shown in FIG. 6, each access point 602a-c preferably is paired with a DVB-T transmitter 612. As such, each access point 602 preferably is associated with the same predetermined area within the plane (e.g., a group of seats) as its DVB-T transmitter 612 counterpart. Each DVB-T transmitter 612a-c also has assigned to it a static IP address, which is stored in access controller 606. Thus, access controller 606 is apprised of all network “nodes” and can perform an intermediate routing function by advising content database server 600 of the appropriate DVB-T transmitter 612 to which the requested content should be sent in order to reach the passenger who originated the request based on the access point 602 and/or MMT 500 from which the request was received. The content is routed to the appropriate DVB-T transmitter 612 through switch 610 using the DVB-T transmitter's IP address.

When a passenger desires to browse content, MMT 500 may search the available frequency bands for the frequency of the DVB-T transmitter 612 serving its area to obtain overhead information. Alternatively, MMT 500 may be pre-tuned to the frequency of that transmitter (particularly in the case of fixed seat-back terminals 500a). MMT 500 will then search the overhead information being broadcast by DVB-T transmitter 612 for packets corresponding to the programming guide (such packets may be identified by a predetermined PID value, which will be discussed in detail hereinafter in connection with FIG. 9). MMT 500 will filter those packets and use them to construct the programming guide.

A user of MMT 500 will then select content from the programming guide for consumption. Selection of content will cause MMT 500 to send a content request message to access controller 606 via the access point 602 serving the area in which the MMT 500 is located. Access controller 606 will respond to the request by transmitting an authentication and billing web page to MMT 500 via the same access point 602 from which it received MMT 500's content request using MMT's IP address (which, as discussed above, may be either statically or dynamically assigned).

Access controller 606 may perform user authentication based on a username/password (e.g., based on the airline's frequent flyer service) or a SIM card entered by the user. The SIM card may hold parameters for RADIUS authentication (username/password) and/or International Mobile Standard Identification (IMSI) for cellular users; the latter being used primarily in a GSM network and permitting GSM users to roam to the system of the present invention and have content downloads billed to their GSM accounts. The SIM card can also hold VPN certificates for use in authentication and/or billing. Moreover, billing may be time based and/or content based and may be charged to a user's credit or debit card number or, as discussed above, the account associated with the user's SIM card. At the end of a session, access controller 606 preferably routes billing information associated with the session to the airline's billing system. The passenger will ultimately get billed for the session through the user's credit card company (e.g., VISA) or cellular or IP access operator associated with the SIM card. In either case, after performing user authentication and billing, access controller 606 instructs content data base server 600 to transmit the requested content to the DVB-T transmitter 612 serving MMT 500. Access controller 606 provides content data base server 600 with the IP address of the DVB-T transmitter 612 serving MMT 500 (and in one embodiment, the IP address of MMT 500) to assist it in that regard.

Each DVB-T transmitter 612 includes a multiplexer 620a, which receives compressed stream(s) corresponding to the requested content. An item of requested content may consist of various components such as video, audio in various languages and teletext. Each of these components comprises a separate elementary stream with a common time reference. The elementary streams received by the DVB-T transmitter 612 are each compressed preferably using MPEG-2 compression. If a higher MPEG standard is used (e.g., MPEG-4 rather than MPEG-2) increased capacity can be achieved as a result of the greater compression albeit at the expense of picture resolution. In order for the elementary streams to be transmitted down the same channel they must be split up into small sections called transport packets. These transport packets are then multiplexed together both with one another and with transport packets of overhead (such as the programming guide and SI channel) aid other content to be broadcast by DVB-T transmitter 612 to MMT's 500 in the area it serves.

The multiplexed transport stream is thereafter sent to encryption module 620b and scrambler 620c. Finally, the scrambled and encrypted transport stream is sent to the over-the-air interface 620d, which performs the necessary functions well-known to those of ordinary skill in the art to broadcast the transport stream over the air.

In accordance with one embodiment of the present invention, the frequency at which each DVB-T transmitter operates is preferably in the 17 GHz range. The 17 GHz frequency range is advantageous primarily because it is a license-free band whose use for streaming services does not presently involve any regulatory issues. Another advantage of using the 17 GHz frequency is that a low power transmitter operating in such a high band will not interfere with sensitive avionics systems, which typically operate in the HF/VHF/UHF bands. However, standard DVB-T frequencies in the VHF/UHF bands can be used in the cabin if tested and approved for safe usage by the aviation regulators (i.e., if testing reveals that there is no interference with the avionics systems).

The transmitter may use any of the modulation schemes specified in the DVB-T standards, such as QPSK, QAM and OFDM since multipath fading is not expected to be a problem in a common carrier environment. Also, error correction coding rates and guard intervals can be selected to obtain an optimal performance vs. bandwidth ratio. In general, suitable DVB-T modes are 64 QAM modes with high coding rates such as ⅔, ¾ or even ⅚ and the shortest possible guard interval of 1/32. Such small guard intervals can be used since the space within the cabin is very limited and thus any echoes will be short.

Typically, one 8 MHz wide RF channel has a capacity of 27.14 Mbps using 64 QAM modulation, a ¾ coding rate and a 1/32 guard interval. Assuming that each stream of content is 4 Mbps, one 8 MHz channel can accommodate up to six streams of content and overhead. Moreover, the content can be encoded, e.g., with MPEG4 at 400 Kbps, which provides sufficient resolution for small displays while saving bandwidth. Thus, for a 400+ seat aircraft, 530 MHz of bandwidth in the 17 GHz range would be needed assuming an individual stream for each passenger. In such an exemplary system, at most 67 DVB-T transmitters would be needed (assuming the worst case of each transmitter accommodating only a single 8 Mhz channel).

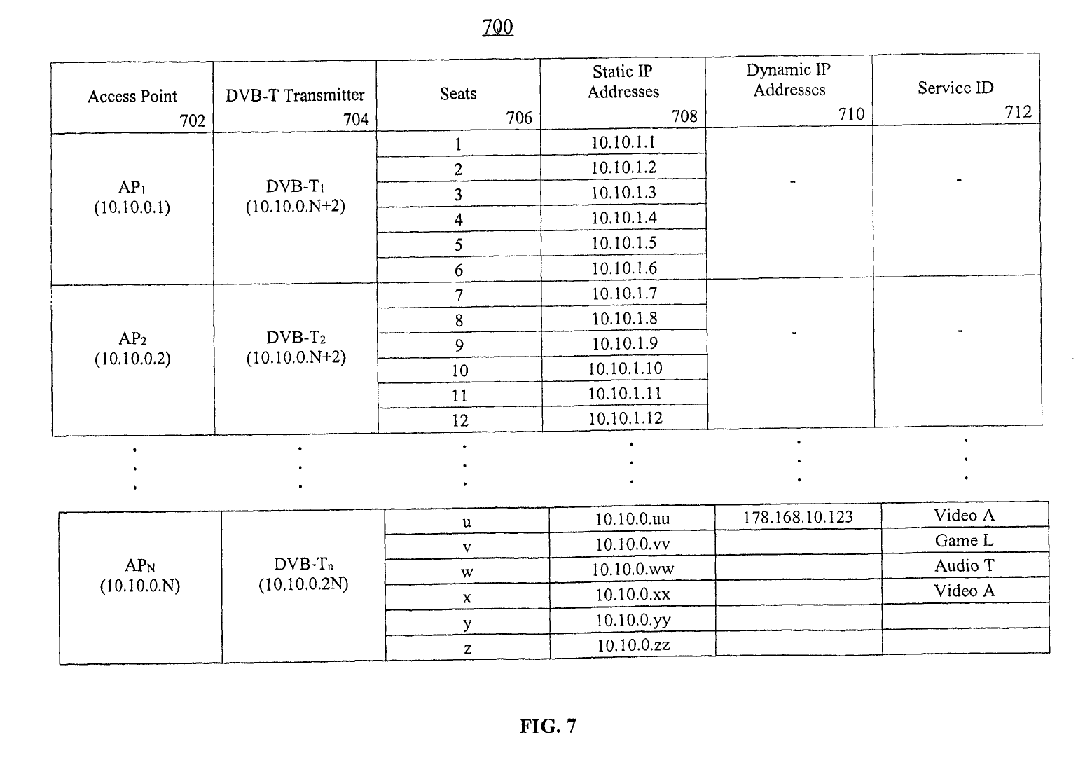

FIG. 7 is an exemplary database used by the system of FIG. 6 in routing content to the MMT 500 of FIG. 5. The database of FIG. 7 preferably resides in access controller 606. As shown in FIG. 7, database 700 includes records for each access point/DVB-T transmitter pair. Each record includes fields for an access point 702 and DVB-T transmitter 704 together with their statically assigned IP addresses. Each record also includes seats served by the access point/DVB-T transmitter pair 706, static IP addresses assigned to fixed seatback terminals associated with those seats 708, dynamic IP addresses assigned to terminals carried on-board by passengers sitting in those seats 710, and service identifiers 712, which identify the particular services requested by a passenger. As discussed above, access controller 606 preferably tracks other information such as user information related to authentication and billing. For ease of illustration, however, those types of information are not shown in FIG. 7.

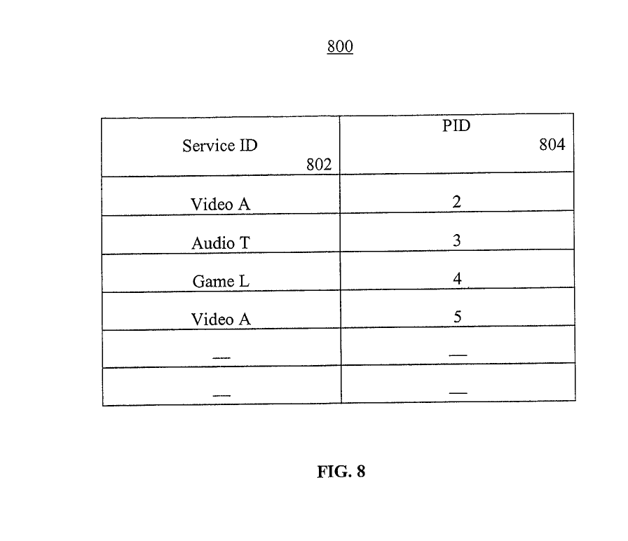

FIG. 8 is an exemplary database used by the system of FIG. 6 in broadcasting content to the MMT 500 of FIG. 5. The database of FIG. 8 preferably resides in a DVB-T transmitter 612. As shown in FIG. 8, database 800 includes records for each item of content being broadcast by the DVB-T transmitter 612. Each record includes fields for a service identifier 802 and a program identifier (“PID”) value 804. The service identifier 802 identifies the content being broadcast, for example, by name. The PID value 804 is a unique code assigned by the DVB-T transmitter 612 to broadcast content, which MMT 500 uses to filter the requested content from the multiplexed transport stream, as will be discussed in detail hereinafter in connection with FIG. 9.

FIG. 9 is a block diagram illustrating an exemplary mechanism for informing a MMT 500a of FIG. 5 of which packets to filter from a multiplexed transport stream in order to receive requested content.

DVB-T transmitter 612c receives content requested by a MMT 500a from content database server 600 via switch 610. The content is received as one or more compressed elementary streams, which DVB-T transmitter will divide into transport packets and then multiplex with transport packets of overhead and content corresponding to other requests (if any). In one embodiment of the present invention, the multiplexed transport stream 900 includes content relating to six separate content requests and overhead, each of which is identified by a unique PID value assigned by the DVB-T transmitter.

As discussed above, the overhead information transmitted in the multiplexed transport stream includes both a programming guide and a SI channel. The packets associated with the programming guide may be identified, for example, by a predefined program identifier (PID) value such as PID 0, and are filtered by MMT 500 to determine the content available for consumption. The SI channel includes packets corresponding to a program association table (PAT) 906, which contains essentially the same information as the DVB-T transmitter database 800 discussed above in connection with FIG. 8—namely, a service identifier and a PID value. The MMT 500 uses the PAT to determine which packets to filter from the digital transport stream in order to receive the requested content.

Thus, in order to filter packets corresponding to the requested content, MMT 500a must first obtain the PAT 906 from the multiplexed transport stream. The packets associated with the PAT 906 may be identified, for example, by a predefined PID value, such as, PID 1. After a content request has been submitted and user authentication and billing has occurred, MMT 500a begins filtering for all transport packets with a PID value of 1. The MMT 500a then uses the filtered packets to construct the PAT 906 shown in FIG. 9. Assuming that a user of MMT 500a has ordered “Video A” from the programming guide, MMT 500a can determine from the PAT 906 (see reference numeral 914 in FIG. 9) that it should filter for packets with a PID value of 5, since that is the PID value that DVB-T transmitter 612c has assigned to “Video A”.

In the event that two MMTs 500 served by the same DVB-T transmitter 612c request the same content at different times, the service identifier 908 may be insufficient to distinguish between two streams delayed in time, which may result in an MMT 500 that requested the content later in time tuning to the stream corresponding to the content already in progress. To prevent this from happening, if access controller 606 determines that DVB-T transmitter 612c will be broadcasting two versions of the same content delayed in time, it instructs the content data base server 600 to request from transmitter 612c the PID value that it will be assigning to the second version of the content. Upon receipt of the PID value from DVB-T transmitter 612c, content database server 600 transmits it to access controller 606, which, in turn, uses the routing table of FIG. 7 to determine the appropriate access point 602c to which the PID value should be sent for transmission via the bi-directional link to MMT 500a. Upon receipt of this PID value, MMT 500a can begin filtering the appropriate packets received over the DVB-T link.

In yet an alternate embodiment for permitting MMT 500a distinguish between two streams of the same content delayed in time, PAT 906 may be populated with the IP address of the terminal that requested the content (in addition to the service identifier and PID value), which permits MMT 500a to determine the PID value of packets that it should be filtering based on its unique IP address, which is either dynamically or statically assigned by the system. In this alternate embodiment, access controller 606 would provide the DVB-T transmitter 612 with the IP address of the MMT 500 that requested the content for use in populating the table of FIG. 8 and the PAT 906.

Returning to the case of a user of MMT 500a who has ordered “Video A”, the PID value of 5 will identify additional packets in the SI channel corresponding to a program map table (“PMT”) (not shown). The PMT correlates one or more elementary streams of which the requested content is comprised (e.g., in the case of, e.g., a movie: video, audio English, audio Finish, etc.) with the PID values of the packets containing the elementary streams. MMT 500a then filters for the PID values of the elementary streams to effectively de-multiplex the content portion of the digital transport stream, thereby obtaining the packets necessary to reconstruct the requested content.

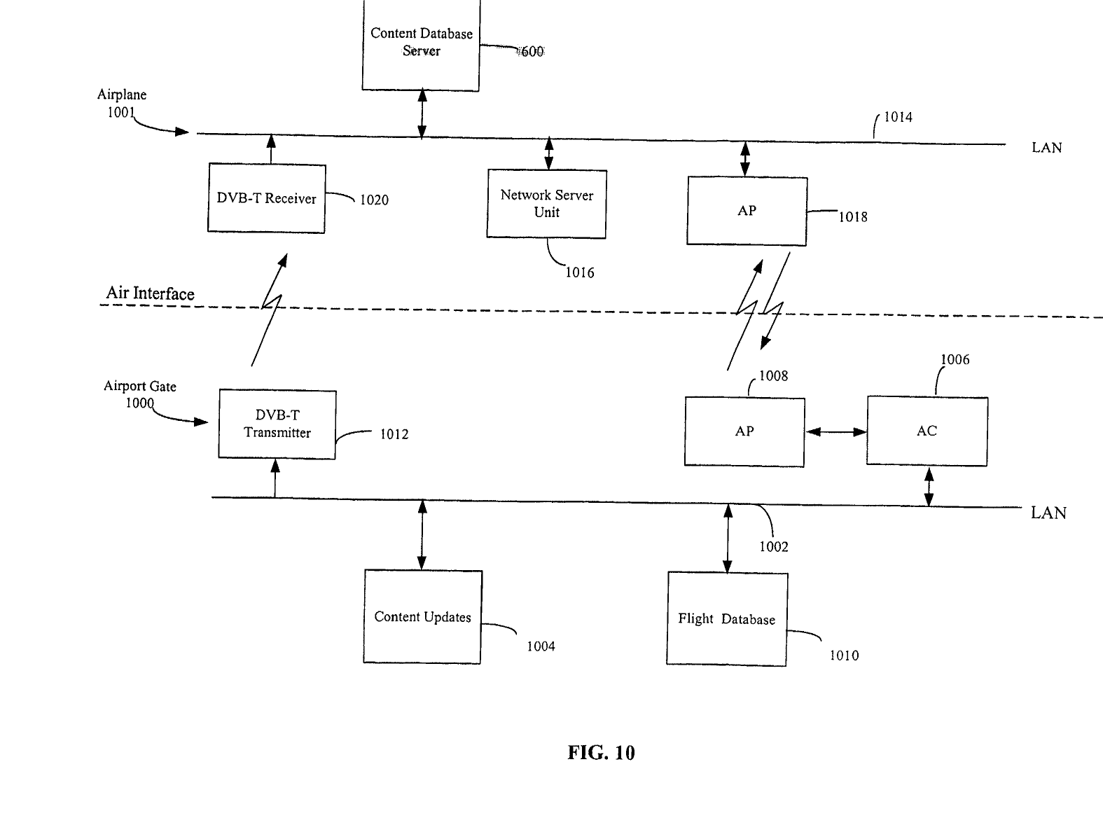

FIG. 10 is a block diagram of an exemplary system for quickly updating content in an airplane's content database server 600 via a DVB-T connection while the airplane 1001 is receiving flight and operational data for its next flight at a terminal gate 1000.

As shown in FIG. 10, terminal gate 1000 includes a local area network (“LAN”) 1002 to which a content database 1004 is connected for storing passenger-consumable content to be downloaded to planes being prepared for their next flight. An airplane may need to have content in its content database server 600 updated depending on such factors as destination, departure date, etc. Various other components are connected to LAN 1002 to facilitate updating content in the plane's content database server 600 in accordance with the present invention. These include an access controller 1006 for controlling an airplane's access to LAN 1002, an access point 1008 for receiving airplane requests for content updates as well as requests for flight and operational data using a wireless protocol such as 2.4 GHz 802.11b WLAN or Bluetooth, a flight database 1010 for storing flight information (destinations, departure times, content packages, etc.) and a DVB-T transmitter 1012 for transmitting content updates to content database server 600 via a DVB-T connection. Alternatively, wireless LAN access point (not shown) or the like, can be used for transmitting content updates to content database server 600.

As also shown in FIG. 10, an airplane 1001 includes a local area network 1014 to which its content database server 600 is connected. Server 600 stores passenger-consumable content. Various other devices aboard the airplane are also connected to LAN 1014 to facilitate updating content in data base server 600. These devices include a network server unit 1016 for requesting updates of both content and flight/operational data, an access point 1018 for both communicating such requests to access controller 1006 of terminal gate 1000 and receiving flight/operational data therefrom, and a DVB-T receiver 1020 for receiving content updates broadcast by DVB-T transmitter 1012. Alternatively, wireless LAN access point (not shown) or the like, can be used for receiving content updates.

To update its passenger consumable content between flights, an airplane 1001 transmits both its plane identifier (typically its tail number, which also corresponds to its static IP address) and an update request to access controller 1006. Advantageously, the update request may be for both flight information and content updates. In response to an update request, controller 1006 accesses flight database 1010 to authenticate the airplane's request and retrieve flight and operational data corresponding to the plane's next flight. Access controller 1006 then begins transmitting the flight information to network server unit 1016 via access point 1008.

Access controller 1006 also accesses flight database 1010 to determine the passenger-consumable content updates needed for the plane's next flight. For example, a particular content package identifier may be associated with the plane's next flight information, and thus, identify the content to be used in updating the airplane's content database server 600 for its next flight. Access controller 1006 preferably would transmit the content package identifier to the network server unit 1016 in the plane via access point 1008 for use by DVB-T receiver 1020 in filtering packets corresponding to the updated content (if less than the entire DVB-T channel were dedicated to the plane's content update). Alternatively, the airplane 1001 could identify to access controller 1006 via access point 1018 the content package identifier corresponding to the content package needed for its next flight after receiving enough updated flight information to make that determination. In this alternate scenario, network server unit 1016 would store a correlation between content package identifiers and flight information. In any event, access controller 1006 then instructs the content data base 1004 to transmit the required content updates to airplane 1001 via the DVB-T transmitter 1012. Alternatively, the content updates may be transmitted to the airplane 1001 via wireless LAN access points (not shown) or the like.

DVB-T receiver 1020 may scan available channel frequencies to determine those to be used for updates or, alternatively, may know that the same predetermined frequencies are always used for such updates. In addition, DVB-T receiver 1020 may determine which packets to filter from information in the SI channel such as a program association table which would correlate content package identifiers and/or the airplane's static IP address to a PID value (once again, if less than the entire DVB-T channel were dedicated to the plane's content update).

The DVB-T network shown in FIG. 10 (namely, DVB-T transmitter 1012 and DVB-T receiver 1020) preferably operates in the 17 GHz band at very low power to cover only the gate premises. It preferably uses 8 MHz channels, which provide approximately 27 Mbit/s throughput (assuming 64 QAM, ¾ coding and 1/32 guard interval). Thus, the content download speeds using the DVB-T network are N*27 Mbit/s where N is the number of channels dedicated to updating content. In accordance with the present invention, the WLAN gate link and DVB-T network can operate simultaneously to download flight data and user-consumable content, respectively, in the relatively short turn around time needed for airplanes at a terminal gate.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the digital receiver is described as a DVB-T receiver. However, the digital data received could be in any of a variety of digital formats, frequencies, protocols, etc. The digital receiver used should be configured to receive the types of data expected. Moreover, the digital receiver could be configured to receive digital information in a variety of formats or receive analog e.g., NTSC or PAL, and digital broadcasts.

For another example, the presently preferred embodiment is described as having only one digital receiver. However, differing embodiments of the MMT may be configured with multiple digital receivers. The use of more than one digital receiver can serve to increase the robustness of the data received in digital broadcast.

For another example, the presently preferred embodiment is described as operating over differing communications links, one at a time. However, it is possible that several of the communications links, e.g., LPRF, WLAN, and/or a wireless mobile station link can be operated at once to send and receive information to multiple places simultaneously.

For another example, while not stated explicitly in the presently preferred embodiment, it is possible to integrate a mobile station into the MMT. An integrated MMT/mobile station would allow the MMT to function as its own IP router or portable base station.

For another example, digital broadcast of data is anticipated in the presently preferred embodiment. However, it is possible that third generation (3G) or greater cellular networks will have the capacity to deliver TV reception and broadband data transmission. The MMT can be equipped with a different or alternate receiver which is configured to receive such digital data.

We claim:

1. A method for distributing digital content in a common carrier environment, comprising:
receiving a request for content from a passenger device via a wireless link; and
transmitting the content to the passenger device using a digital data broadcast capability.

2. The method of claim 1, further comprising:
receiving authentication information from the passenger device.

3. The method of claim 1, further comprising:
receiving a SIM card parameter; and
using the parameter for authentication and/or billing.

4. The method of claim 3 wherein the parameter is a username/password.

5. The method of claim 3, wherein the parameter is an International Mobile Station Identifier of a GSM system.

6. The method of claim 3 wherein the passenger device is one that has roamed into an area in which content can be transmitted using the digital data broadcast capability and wherein the parameter permits the content to be billed to an account associated with the passenger device.

7. The method of claim 6 wherein the account is a GSM account.

8. The method of claim 1 wherein the wireless link is a short range wireless link.

9. The method of claim 8 wherein the short range wireless link is a WLAN or Bluetooth link.

10. The method of claim 1 wherein the digital data broadcast capability is a DVB-T capability.

11. The method of claim 1 wherein the passenger device is a fixed seatback terminal or a passenger carried terminal.

12. The method of claim 1 wherein the common carrier environment is an airplane.

13. A method for receiving digital content in a common carrier environment, comprising:
transmitting, from a passenger device, a request for content via a wireless link; and
receiving the content at the passenger device via a digital data broadcast capability.

14. The method of claim 13, further comprising:
transmitting authentication information from the passenger device.

15. The method of claim 13, further comprising:
transmitting, from the passenger device, a SIM card parameter for authentication and/or billing.

16. The method of claim 15, wherein the parameter is a username/password.

17. The method of claim 15, wherein the parameter is an International Mobile Station Identifier of a GSM system.

18. The method of claim 13, further comprising:
transmitting an audio portion of the content from the passenger device to a passenger headset via a low power wireless connection.

19. The method of claim 18, wherein the low power wireless connection is a Bluetooth connection.

20. A method for distributing digital content on-demand to passengers in an airplane, comprising:
receiving a request for content from a passenger terminal via a wireless LAN access point; and
transmitting the content to the passenger terminal via a DVB-T transmitter.

21. The method of claim 20 wherein the terminal is either a fixed seat back terminal or a passenger carried terminal.

22. A system for distributing digital content on-demand to passengers in an airplane, comprising:
a terminal for transmitting a passenger request for content and for receiving content in response thereto;
a server for responding to the passenger request for content;
an access point coupled to the server for receiving the passenger request for content from the terminal via a short range wireless link and communicating the request to the server; and
a digital data broadcast transmitter for broadcasting requested content from the server to the terminal.

23. The system of claim 22 wherein the server comprises a storage medium for storing content.

24. The system of claim 22 wherein the server comprises an access controller for controlling access to the content.

25. The system of claim 24 wherein the access controller authenticates the request for content.

26. The system of claim 25, wherein the authentication includes receiving a SIM card parameter and using the parameter for authentication and/or billing.

27. The system of claim 26, wherein the parameter is a username/password.

28. The system of claim 26 wherein the parameter is an International Mobile Station Identifier of a GSM system.

29. The system of claim 26 wherein the parameter is received from a terminal that has roamed into an area served by the system and is used to bill the requested content to a GSM account of the terminal.

30. The system of claim 22 wherein the access point is coupled to the server via a local area network (“LAN”).

31. The system of claim 22 wherein the short range wireless connection is a WLAN or Bluetooth connection.

32. The system of claim 22 wherein the digital data broadcast transmitter is a DVB-T transmitter.

33. The system of claim 22 wherein the terminal is either a fixed seat-back terminal or a passenger carried terminal.

34. The system of claim 22 wherein the passenger request is communicated to the server via an access controller.

35. A system for distributing digital content on-demand to passengers in an airplane, comprising:
a plurality of terminals for transmitting requests for content and for receiving content in response to the requests;
a storage medium for storing content;
an access controller for controlling access to the content;
a plurality of access points coupled to the access controller via a local area network for receiving requests for content from the terminals via a short range wireless link and communicating the requests to the access controller; and
a plurality of digital data broadcast transmitters for broadcasting requested content from the storage medium to the terminals.

36. The system of claim 35 wherein the digital data broadcast transmitters are DVB-T transmitters.

37. The system of claim 35, wherein each of the access points and each of the DVB-T transmitters serve terminals in a predetermined area of the airplane.

38. The system of claim 37 wherein the predetermined area comprises a predetermined number of seats.

39. The system of claim 35 wherein the access controller authenticates the request for content.

40. The system of claim 39, wherein the authentication includes receiving a SIM card parameter and using the parameter for authentication and/or billing.

41. The system of claim 40, wherein the parameter is a username/password.

42. The system of claim 40 wherein the parameter is an International Mobile Station Identifier of a GSM system.

43. The system of claim 42 wherein the parameter is received from a terminal that has roamed into an area served by the system and is used to bill the requested content to a GSM account of the terminal.

44. A system for distributing digital content on-demand to passengers in an airplane, comprising:
a storage medium for storing content;
an access controller for controlling access to the content;
a plurality of access points coupled to the access controller for receiving requests for content from the terminals via a short range wireless link and communicating the requests to the access controller; and
a plurality of digital data broadcast transmitters for broadcasting requested content from the storage medium to the terminals.

45. The system of claim 44 wherein the digital data broadcast transmitters are DVB-T transmitters.

46. The system of claim 44, wherein the access points are coupled to the access controller via a local area network.

47. The system of claim 44 wherein the short range wireless link is either a WLAN or Bluetooth link.

48. The system of claim 44 wherein content in the storage medium is updated via a DVB-T connection while the airplane is at a terminal gate.

49. The system of claim 44 wherein the access controller authenticates the request for content.

50. The system of claim 49, wherein the authentication includes receiving a SIM card parameter and using the parameter for authentication and/or billing.

51. The system of claim 50, wherein the parameter is a username/password.

52. The system of claim 50 wherein the parameter is an International Mobile Station Identifier of a GSM system.

53. The system of claim 52 wherein the parameter is received from a terminal that has roamed into an area served by the system and is used to bill the requested content to a GSM account of the terminal.

54. A system for distributing digital content on-demand to passengers in an airplane, comprising:
a storage medium for storing content;
an access controller for controlling access to the content;
an access point coupled to the access controller for receiving requests for content from a plurality of terminals via a short range wireless link and communicating the requests to the access controller; and
a digital data broadcast transmitter for broadcasting requested content from the storage medium to the terminals.

55. The system of claim 54 wherein the digital data broadcast transmitter is a DVB-T transmitter.

56. The system of claim 54 wherein the access point and the digital data broadcast transmitter serve terminals in a particular area of the airplane.

57. The system of claim 54 wherein the access controller authenticates the request for content.

58. The system of claim 57, wherein the authentication includes receiving a SIM card parameter and using the parameter for authentication and/or billing.

59. The system of claim 58, wherein the parameter is a username/password.

60. The system of claim 58 wherein the parameter is an International Mobile Station Identifier of a GSM system.

61. The system of claim 60 wherein the parameter is received from a terminal that has roamed into an area served by the system and is used to bill the requested content to a GSM account of the terminal.

62. A system for updating passenger-consumable content in an airplane's content data base while the airplane is at a gate of an airport terminal, comprising
a storage medium for storing content;
an access controller;
an access point coupled to the access controller via a local area network for receiving a request for content from the airplane via a short range wireless link and communicating the request to the access controller; and
a digital data broadcast transmitter for broadcasting requested content from the storage medium to the airplane to update the airplane's content data base.

63. The system of claim 62 wherein the digital data broadcast transmitter is a DVB-T transmitter.

64. The system of claim 62, wherein the access controller controls access to a local area network of the airport terminal.

65. The system of claim 62, wherein the access point receives requests for flight data from the airplane and transmits the flight data to the airplane via the short range wireless link.

66. A system for updating passenger-consumable content in an airplane's content data base while the airplane is at a gate of an airport terminal, comprising
a storage medium for storing content;
an access controller for controlling access to flight data and content;
a first access point coupled to a local area network for transmitting flight data to the airplane via a first short range wireless link; and
a second access point coupled to the local area network for transmitting requested content from the storage medium to the airplane via a second short range wireless link to update content in the airplane's content data base.

67. The method of claim 66, wherein the access controller receives requests for flight data and content from the airplane via the first short range wireless link.

68. The method of claim 66 wherein the transmission of flight data via the first short range wireless link and the transmission of the content via the second short range wireless link occurs substantially simultaneously.

69. In a system for distributing digital content on-demand to a plurality of passenger terminals in an airplane, the terminals for transmitting requests for content and for receiving content in response thereto,
a server for responding to passenger requests for content;
a plurality of access points coupled to the server for receiving requests for content from the terminals via a short range wireless link and communicating the requests to the server; and
a plurality of digital data broadcast transmitters for broadcasting requested content from the server to the terminals.

70. The system of claim 69 wherein the server comprises a storage medium for storing content.

71. The system of claim 69 wherein the server comprises an access controller for controlling access to the content.

72. The system of claim 69 wherein the server authenticates the requests for content.

73. The system of claim 72, wherein the authentication includes receiving a SIM card parameter and using the parameter for authentication and/or billing.

74. The system of claim 73, wherein the parameter is a username/password.

75. The system of claim 73 wherein the parameter is an International Mobile Station Identifier of a GSM system.

76. The system of claim 75 wherein the parameter is received from a terminal that has roamed into an area served by the system and is used to bill the requested content to a GSM account of the terminal.
